(19) United States
(12) Patent Application Publication
(10) Pub. No.: US 2026/0214418 A1
(43) Pub. Date: Jul. 23, 2026

(54) SENSING OBJECTS IN AN ENVIRONMENT

(71) Applicant: Telefonaktiebolaget LM Ericsson (publ), Stockholm (SE)

(72) Inventors: Athanasios KARAPANTELAKIS, Voula (GR); Hossein SHOKRI GHADIKOLAEI, Täby (SE); Maxim TESLENKO, Sollentuna (SE); Abdulrahman ALABBASI, Kista (SE); Xin TAO, Stockholm (SE); Konstantinos VANDIKAS, Solna (SE)

(73) Assignee: Telefonaktiebolaget LM Ericsson (publ), Stockholm (SE)

(21) Appl. No.: 19/158,144

(22) PCT Filed: May 12, 2023
(86) PCT No.: PCT/SE2023/050468

§ 371 Date: Aug. 20, 2025

(30) Foreign Application Priority Data
Feb. 24, 2023 (GR) 20230100166

(51) Int. Cl. H04W 4/38

(52) U.S. Cl. CPC H04W 4/38

(57) ABSTRACT

According to an aspect, there is provided a computer-implemented method performed by a network node in a communication network. The method comprises: forming one or more clusters of wireless devices that are attached to the network node, wherein each cluster comprises two or more wireless devices; for a first cluster, transmitting, to a first wireless device in the first cluster, a request for objects in an environment in which the two or more wireless devices are located to be sensed; and receiving, from a wireless device, information relating to sensed objects.

### TECHNICAL FIELD

This disclosure relates to sensing objects in an environment, and in particular to techniques for improvements in the sensing of objects in an environment by wireless devices in a network.

### BACKGROUND

In Joint Communication and Sensing (JCAS) networks, the same spectrum and radio/antenna hardware are used for both communication and sensing services. As this spectrum is finite, it will be appreciated that in these networks there will be a trade-off between using part of this spectrum for sensing, and part of this spectrum for communication. As a result, situations may then arise in which resource shortage results in a compromise in the quality of service for one or both of these services.

FIG. 1 shows a communication network 100. In this illustrated example, the network 100 is a JCAS network. The network 100 comprises a base station (in this case a 5th Generation (5G) Node-B, or gNB, but other types of radio access technology (RAT) and base stations can be used) 102, wireless devices 104a, 104b, 104c, 104d and objects 106a, 106b, 106c, 106d. In this network 100, a radio belonging to the base station 102 performs object sensing to sense the wireless devices 104a, 104b, 104c, 104d and the objects 106a, 106b, 106c, 106d. One or more of the wireless devices 104a, 104b, 104c, 104d may be attached to the base station 102, and able to communicate with the base station 102. Therefore, in the network 100, the base station 102 may be communicating with each of the wireless devices 104a, 104b, 104c, 104d (or otherwise be able to detect the signals from the wireless devices 104a-d), and may be transmitting beacon signals to sense each of the objects 106a, 106b, 106c, 106d.

In this disclosure, the term “object” is used to describe an entity that has no means of communication with a base station. An object can include inanimate objects (e.g. walls, buildings, etc.), and objects that can or are moving (e.g. people, vehicles, etc.).

A base station can be more generally referred to as a network node, and can include any type of radio access network (RAN) node, such as a gNB, an eNB, a wireless access point (AP), or an access point.

Performing object sensing may comprise any one of: determining a location of an object, tracking an object, determining a composition of an object, and determining dimensions of an object.

Current approaches attempt to prevent resource shortages from the perspective of clustering many wireless devices together based on their position, velocity, and direction of travel. For each cluster, a head wireless device is then selected to aggregates traffic from the other wireless devices within the cluster, and communicate with the base station, in order to save bandwidth (as the base station now only has to communicate with the head wireless device, rather than all of the wireless devices in the cluster). As discussed in [5], adaptive and efficient clustering of wireless devices may be enabled by a reconfigurable software-defined network (SDN), which monitors and predicts the location of arriving wireless devices (such as vehicles, for example) and informs the base station of this information in advance. [6] provides a survey on existing solutions for clustering wireless device, and a number use cases for these solutions, that are known it the art.

Current approaches therefore examine adaptive clustering of wireless devices from the perspective of improving bandwidth for communication in JCAS networks. However, in these approaches, the base station continues to perform object sensing in the network.

Wireless devices (also referred to as “user equipment”, or UEs, herein) are becoming increasingly capable of sensing their surroundings with precision. For example, technologies such as Device to Device (D2D) communication allow these devices to communicate amongst themselves, and sensing algorithms (such as those described in [1]) allow these devices to locate each other. The computational capacity of these devices is also increasing, similarly to energy autonomy (e.g., vehicles).

### SUMMARY

The problem in short, given the above discussion, is that object sensing techniques can be resource intensive.

Certain aspects of the disclosure and their embodiments may provide improvements or solutions to these or other challenges.

This disclosure provides techniques that enable wireless devices in a network to be clustered for performing object sensing in the environment. This disclosure also provides techniques for delegating the task of object sensing from a base station (or another suitable network node), to one or more wireless devices in a cluster of wireless devices. This disclosure also provides techniques that enable a cluster head (or head wireless device) to be selected for providing object sensing-related information to a base station, or another suitable network node.

According to a first aspect, there is provided a computer-implemented method performed by a network node in a communication network. The method comprises forming one or more clusters of wireless devices that are attached to the network node, wherein each cluster comprises two or more wireless devices. The method further comprises, for a first cluster, transmitting, to a first wireless device in the first cluster, a request for objects in an environment in which the two or more wireless devices are located to be sensed. The method further comprises receiving, from a wireless device, information relating to sensed objects.

According to a second aspect, there is provided a computer-implemented method performed by a first wireless device in a communication network. The method comprises receiving, from a network node, a request for objects in an environment in which the first wireless device is located to be sensed. The method further comprises sensing objects in the environment. The method further comprises sending information relating to sensed objects to the network node or a second wireless device in the communication network.

According to a third aspect, there is provided a computer-implemented method performed by a second wireless device in a communication network. The method comprises receiving, from a first wireless device, a request for objects in an environment in which the second wireless device is located to be sensed. The method further comprises sensing objects in the environment. The method further comprises sending information relating to sensed objects to the first wireless device or a network node in the communication network.

According to a fourth aspect, there is provided a computer program product comprising a computer readable medium having computer readable code embodied therein, the computer readable code being configured such that, on execution by a suitable computer or processor, the computer or processor is caused to perform the method of the first aspect, the second aspect, the third aspect, or any embodiment thereof.

According to a fifth aspect, there is provided a network node for use in a communication network. The network node is configured to: form one or more clusters of wireless devices that are attached to the network node, wherein each cluster comprises two or more wireless devices; for a first cluster, transmit, to a first wireless device in the first cluster, a request for objects in an environment in which the two or more wireless devices are located to be sensed; and receive, from a wireless device, information relating to sensed objects.

According to a sixth aspect, there is provided a first wireless device for use in a communication network. The first wireless device is configured to: receive, from a network node, a request for objects in an environment in which the first wireless device is located to be sensed; sense objects in the environment; and send information relating to sensed objects to the network node or a second wireless device in the communication network.

According to a seventh aspect, there is provided a second wireless device for use in a communication network. The second wireless device is configured to: receive, from a first wireless device, a request for objects in an environment in which the second wireless device is located to be sensed; sense objects in the environment; and send information relating to sensed objects to the first wireless device or a network node in the communication network.

According to an eighth aspect, there is provided a network node for use in a communication network. The network node comprises a processor and a memory, said memory containing instructions executable by said processor whereby said network node is operative to: form one or more clusters of wireless devices that are attached to the network node, wherein each cluster comprises two or more wireless devices; for a first cluster, transmit, to a first wireless device in the first cluster, a request for objects in an environment in which the two or more wireless devices are located to be sensed; and receive, from a wireless device, information relating to sensed objects.

According to a ninth aspect, there is provided a first wireless device for use in a communication network. The first wireless device comprises a processor and a memory, said memory containing instructions executable by said processor whereby said first wireless device is operative to: receive, from a network node, a request for objects in an environment in which the first wireless device is located to be sensed; sense objects in the environment; and send information relating to sensed objects to the network node or a second wireless device in the communication network.

According to a tenth aspect, there is provided a second wireless device for use in a communication network. The second wireless device comprises a processor and a memory, said memory containing instructions executable by said processor whereby said second wireless device is operative to: receive, from a first wireless device, a request for objects in an environment in which the second wireless device is located to be sensed; sense objects in the environment; and send information relating to sensed objects to the first wireless device or a network node in the communication network.

Certain embodiments may provide one or more of the following technical advantage(s). For example, the techniques described herein allow a base station to save spectrum and/or resources that previously would have been allocated for object sensing, as the task of object sensing has now been delegated to a cluster of wireless devices. The techniques described herein also allow a base station to spend less energy resources, as the base station only has to communicate with a head wireless device in order to obtain object-sensing information (rather than having to transmit beacon signals to every object that is being sensed, and then process each individual report). It will be appreciated these resources may then be reallocated to other tasks that are to be performed by the base station (such as addressing congestion, for example).

The techniques described herein may also enable more accurate object sensing in scenarios in which there is an obstruction of line of sight (LOS) between the base station and an object, as the task of object sensing can be offloaded to a wireless device that may not have an obstructed LoS to the object.

### BRIEF DESCRIPTION OF THE DRAWINGS

Some of the embodiments contemplated herein will now be described more fully with reference to the accompanying drawings, in which:

FIG. 1 shows a communication network 100;

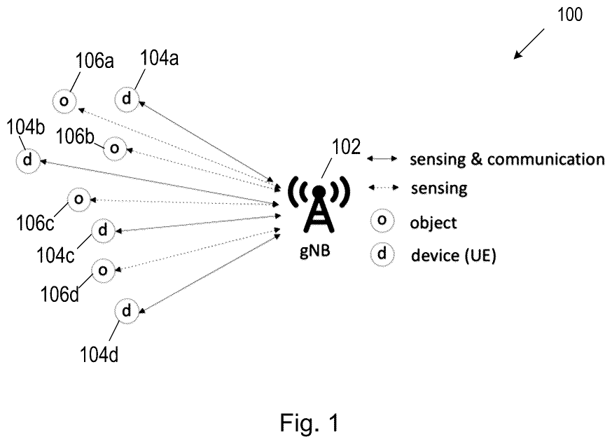

FIGS. 2a and 2b show a communication network 200;

FIG. 3 shows an example of information that may be transmitted in a broadcast message in a communication network 300;

FIG. 4 shows a communication network 400;

FIG. 5 is a flow chart illustrating a computer-implemented method according to various embodiments performed by a network node in a communication network;

FIG. 6 is a flow chart illustrating a computer-implemented method according to various embodiments performed by a first wireless device in a communication network;

FIG. 7 is a flow chart illustrating a computer-implemented method according to various embodiments performed by a second wireless device in a communication network;

FIG. 8 is a simplified block diagram of a network node 800 according to various embodiments; and

FIG. 9 is a simplified block diagram of a first wireless device 900 according to various embodiments.

### DETAILED DESCRIPTION

As noted above, this disclosure provides improvements to object sensing by a communication network.

The techniques described herein enable wireless devices in a network to be clustered for the purpose of performing object sensing in the environment. Some embodiments enable the task of object sensing to be delegated from a base station to a cluster of wireless devices, and enable a head wireless device to be selected within a cluster for relaying object sensing-related information to a base station.

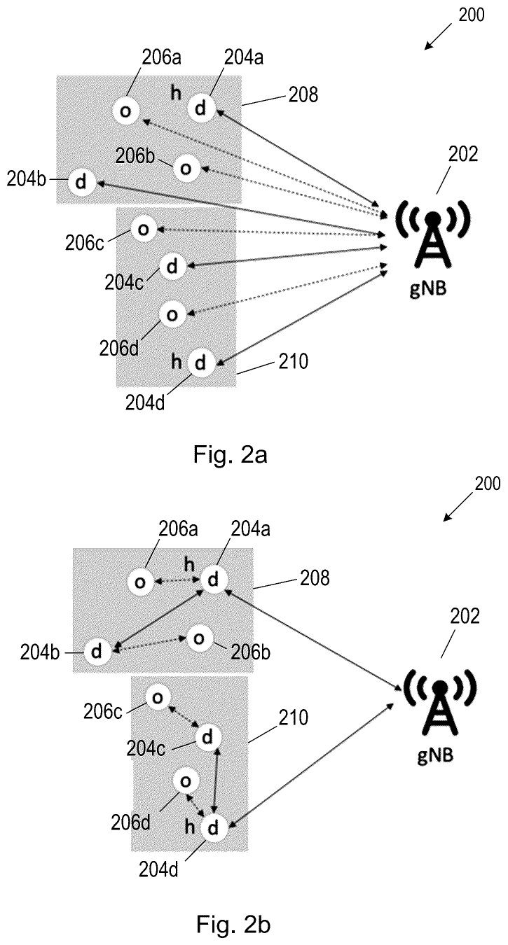

An example implementation of a method according to the present disclosure is described with reference to FIGS. 2a and 2b.

FIGS. 2a and 2b show a communication network 200. The network 200 comprises a base station (in this case a 5G Node-B, or gNB) 202, wireless devices 204a, 204b, 204c, 204d and objects 206a, 206b, 206c, 206d that have been previously sensed by the base station 202. Each of the wireless devices 204a, 204b, 204c, 204d are attached to the base station 202, and able to communicate with the base station 202.

In this embodiment, the object sensing method is performed in response to an event at the base station 202. This event triggers the base station 202 to start the object sensing method in which it forms one or more clusters of wireless devices, and delegates the task of object sensing to this/these clusters of wireless devices.

In some embodiments, the event may comprise insufficient accuracy in the detection, by the base station 202, of objects in the environment in which the base station 202 is located. In this example, the base station 202 may determine that it cannot perform object sensing with sufficient accuracy, and so the base station 202 is to delegate the task of object sensing to one or more clusters of wireless devices. In some embodiments, insufficient accuracy in the detection may be caused by a temporal phenomenon, such as rain. In another embodiment, insufficient accuracy in the detection may be caused by obstacles in the field of view (line of sight) of base station 202.

In some embodiments, insufficient accuracy in the detection may be detected by the base station 202 when a ratio of a measured number of successfully received beacon signals, to a total number of transmitted beacon signals, is determined to be below a particular threshold.

In some embodiments, the result of a maximum a posteriori ratio test (MAPRT) may indicate insufficient accuracy in the detection by the base station 202. That is, the result of a MAPRT may be the event at the base station 202. In a MAPRT, hypothesis testing is considered (H0 where no object is sensed, and H1 where an object is sensed). MAPRT finds the a (the unknown channel gain of a reflected multi-path signal) that maximizes the ratio of the probability distribution of a received signal Y given a and H1, multiplied by the conditional distribution of a given H1, divided by the probability distribution of Y given H0. The MAPRT 35 is then compared to a threshold to determine whether H1 or H0 is correct. The MAPRT is then compared to a realistic version of the sensed object to find the accuracy and false alarm. That is, if the MAPRT indicates that the sensed object could be a vehicle, the MAPRT can be compared to a realistic model/expectation of what would be sensed if the object was a vehicle.

In some embodiments, the event may be a detection or prediction of congestion at the base station 202. In this example, the event relates to the base station 202 requiring additional resources to address the congestion, and the base station 202 deciding to delegate the task of object sensing to one or more clusters of wireless devices. For example, if a number of wireless devices with mission-critical traffic are expected to attach to (or are attached to) the base station 202, additional resources may need to be made available to address this. In another example, if a number of wireless devices in communication with the base station 202 generate an amount of traffic, or an amount of a particular type of traffic (for example, high priority traffic) that exceeds a particular threshold, additional resources in the base station 202 may need to be made available to address this. By delegating the task of object sensing to one or more clusters of wireless devices, the base station 202 is then able to reallocate the resources that were previously allocated for object sensing, to tasks that address or support these situations.

For example, congestion at the base station 202 may be detected when the total amount of requested throughput from a wireless device attached to the base station 202 is greater than the bandwidth that the radio can support. In another example, congestion at the base station 202 may be predicted when the load of the baseband components of the base station 202 exceeds a particular threshold. In another example, congestion at the base station 202 may be predicted when the total number of wireless devices attached to the base station exceeds a particular threshold. In some embodiments, the detections or predictions of congestion at the base station 202 may be determined based on historical data (for example, the detections or prediction may be made using models that have been trained with supervised learning).

In some embodiments, the event may comprise insufficient resources available at the base station 202 to perform sensing of objects in the environment in which the base station 202 is located. For example, this may occur when the base station 202 is already using additional resources to support the communications service.

In some embodiments, the event may comprise a possibility to save energy at the base station 202.

In response to the event at the base station 202, the base station 202 forms two clusters of wireless devices, cluster 208 and cluster 210. Clusters may also include one or more objects 206 that have already been sensed by the base station 202. Thus, each of the clusters 208 and 210 comprise two of the wireless devices, and two of the objects that have been sensed by the base station 202. Cluster 208 comprises objects 206a and 206b, and wireless devices 204a and 204b. Cluster 210 comprises objects 206c and 206d, and wireless devices 204c and 204d. The clusters 208 and 210 are formed such that the at least one wireless device 204 in each cluster is able to perform object sensing and relay object sensing data to the base station 202. In some embodiments, the clusters may be formed, in part, based on the event that triggered the execution of the method.

In this illustrated embodiment, the one or more clusters are formed in a centralised manner (that is, the clusters are formed by the base station 202). Examples of constrained clustering algorithms, that may be utilised by the base station 202 to form clusters of wireless devices, are described in [2].

The base station 202 may cluster a plurality of wireless devices in the network 200 into the one or more clusters according to one or more of: mobility characteristics of the wireless devices; an ability of wireless devices in a cluster to communicate with each other; and a position of the wireless devices with respect to one or more objects previously sensed by the base station 202. It will be appreciated that, if the wireless devices in a particular cluster are located more closely to the objects in that cluster, the object sensing later performed by these wireless devices may be more accurate.

The mobility characteristics of the wireless devices may comprise one or more of: a location of each of the one or more wireless devices, a velocity of each of the one or more wireless devices, and a bearing of the one or more wireless devices. Clustering the wireless devices according to these characteristics may allow the base station 202 to form clusters that enable more accurate object sensing, as both the current and future locations of the wireless devices are considered in the cluster formation process.

An ability of wireless devices in a cluster to communicate with each other may be determined based on one or more of: one or more direct connections between the wireless devices (for example, D2D connections); one or more indirect connections between the wireless devices (for example, connections between wireless devices via the base station 202 and/or one or more other wireless devices); one or more radio connections between the wireless devices and/or the wireless devices and the base station 202; and a received radio power at one or more wireless devices and/or the base station.

It will be appreciated that, in embodiments in which each cluster further comprises one or more objects that have previously been sensed by the base station 202, the clusters may be formed based on the mobility characteristics of the objects previously sensed by the base station 202.

In some embodiments, the base station 202 may form the one or more clusters based on one or more constraints. In some embodiments, the one or more constraints may comprise a constraint that each formed cluster should comprise at least one wireless device that is capable as acting as a head wireless device (also referred to herein as a first wireless device, a lead wireless device or a leader wireless device). As noted above, it is the head wireless device that communicates the information relating to objects sensed by the wireless devices in the cluster to the base station 202, and optionally also relays the communication data of the other wireless devices in the cluster to the base station 202. Characteristics that may be considered when selecting a head wireless device for a cluster are described in greater detail below, and the one or more constraints may comprise one or more of these later described characteristics.

In some embodiments, the one or more constraints may comprise a constraint that all of wireless devices in a cluster are able to communicate with each other. This communication may be direct communication and/or via relay.

In some embodiments, the one or more constraints may comprise a constraint that all the objects within a cluster (that have been previously sensed by the base station 202) can be sensed by one or more of the wireless devices in the cluster.

In some embodiments, the one or more constraints may comprise a constraint that the wireless devices should be clustered in a manner that does not cause congestion, or that does not result in congestion that exceeds a particular acceptable level of congestion, and/or clustered in a manner that does not result in interference that exceeds a particular acceptable level of interference.

In an alternative embodiment, a step of forming one or more clusters of wireless devices may comprise transmitting, to one or more of the wireless devices attached to the base station 202, a request for the wireless device(s) to form the one or more clusters. Upon receiving this message, the clusters may be formed according to a distributed clustering algorithm between the wireless devices and the sensed objects. One or more of the wireless devices may execute the distributed clustering algorithm. The request to form the clusters may be transmitted by the base station 202 in a broadcast message. The request may comprise information relating to the objects previously sensed by the base station 202, for example, the locations of the objects.

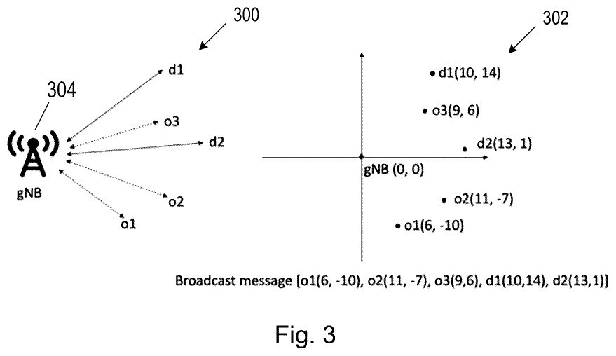

FIG. 3 shows an example of the information that may be transmitted in a broadcast message in a communication network 300. In FIG. 3, the broadcast message 302 comprises the locations of the objects o1, o2, o3 that have been sensed by the base station 304, and the wireless devices d1, d2 attached to the base station 304, with respect to the location of the base station 304. In this example, the locations of the objects o1, o2, and o3 are represented using grid coordinates. Cell broadcast functionality is described in [3] for Long Term Evolution (LTE), and [4] for 5G.

Following the formation of the clusters 208 and 210, for each of the clusters 208 and 210, the base station 202 selects a wireless device to be a head wireless device from the wireless devices within each cluster. As noted above, the head wireless device is also referred to herein as a “first wireless device” or a lead wireless device. This selection process can be referred to as a ‘leader election process’. Leader election processes/algorithms are known in distributed systems, and such techniques can be used or adapted for use with the techniques described herein.

In this illustrated embodiment (FIG. 2b), the wireless device 204a is selected as the head wireless device for the cluster 208, and the wireless device 204d is selected as the head wireless device for the cluster 210. Following this selection, the base station 202 then only has to communicate with the head wireless devices in order to receive the object sensing information obtained by the wireless devices in the clusters, as shown in FIGS. 2a and 2b. In this embodiment, the head wireless device for a cluster is selected based on its ability to obtain object sensing information relating to the cluster, and its ability to communicate with the base station (in other words, its suitability to act as a head device).

In some embodiments, the first wireless device is selected according to one or more of: mobility characteristics; a number of hops between a wireless device in the cluster and the other wireless devices in the cluster; traffic level, throughput, and/or load profile of the wireless device; availability of resources in the wireless device; a position of the wireless device in the environment (such as a relative position (for example, relative to the position of the base station 202), or an absolute position (for example, a latitude and a longitude); an indication of a quality of communication between the wireless device and the base station 202; whether the wireless device has a line of sight to the base station 202. The mobility characteristics may comprise one or more of a direction of movement (or bearing), a velocity and an acceleration. In some embodiments, it is desirable that the wireless device selected as the cluster head has the other wireless devices in the cluster as “close” to it as possible, where this closeness is defined by the number of intermediate nodes required to reach those other devices.

Some embodiments may require that, for a particular wireless device to be selected as the head wireless device, that one or more of these aforementioned criteria must be considered fulfilled. In some embodiments, for a particular wireless device to be selected as a cluster head, a criterion that may need to be fulfilled by the wireless device (in order to be selected as head) is that the wireless device is equipped with a local sensing system (that is, that the wireless device is capable of performing object sensing). A number of local sensing methods are described in [1], any of which can be used by the wireless devices described herein. In some embodiments, fulfilling this criterion may further require that the local sensing system is suitable for a particular scenario. For example, if it is raining, certain local sensing methods, such as vision-based ones, may not provide accurate local positioning, and thus, a wireless device equipped with a vision-based sensing method may not be suitable to be selected as a head wireless device. In some embodiments, fulfilment of a particular criterion may be measured using a suitability index. A suitability index can comprise a normalized value that indicates the likelihood for a particular wireless device to act as the head wireless device of the cluster.

Examples of how these suitability indices may be calculated are now described.

Given a particular wireless device (UEx) in a particular cluster, a mobility characteristic suitability index (ms) may be determined based on the camp time of the cell as follows:

$${ms}_{UEx} = \{ \begin{matrix}\frac{{ct\_ue}_{x}}{{reft}_{uex}} if {ct}_{{ue}_{x}} \leq {reft}_{uex} \\ 1 if {ct}_{uex} > {reft}_{uex}\end{matrix}$$

In some embodiments, a mobility characteristic suitability index for the particular wireless device may be determined based on camping probabilities, rather than based on explicit values.

$${ms}_{UEx} = \{ \begin{matrix}\frac{{\int }_{0}^{T} {P}_{\{ {ct}_{{ue}_{x}} \}} dc}{{reft}_{uex}} , if {\int }_{0}^{T} {P}_{\{ {ct}_{{ue}_{x}} \}} dc \leq {reft}_{uex} \\ 1 if {ct}_{uex} > {reft}_{uex}\end{matrix}$$

where ct is the camp time of UEx in the serving cell and reft is a preset reference time which represents a theoretical ideal for the purpose of a wireless device serving as a cluster head.

In some embodiments, the mobility characteristic suitability index encompasses relative movement of a wireless device in relation to the other wireless devices in the cluster. This may be utilised in more dynamic scenarios, in which the wireless devices are moving. For example, the mobility characteristic suitability index may be determined based on the handover history of every wireless device in the cluster. Given n wireless devices (UEs) in cluster c: c={UE1, . . . , Uen}, such that UEₖ={cellid₁, . . . cellidₘ} indicating last number of m hops for last X number of minutes (where X is a preset value), for every UEₖ belonging to c, then

$${ms}_{UEk} = \frac{{\sum }_{m = 1}^{n , m != k} J ( {UE}_{m} , {UE}_{k} )}{n} = \frac{{\sum }_{m = 1}^{n , n != k} \frac{\vert {UE}_{m} ⋂ {UE}_{k} \vert}{\vert {UE}_{m} ⋃ {UE}_{k} \vert}}{n}$$

In this example, the sum of the Jaccard Distance J (or Jaccard Similarity coefficient) of the set of hops of the wireless device with the set of hops from all other wireless devices in the cluster is calculated. This sum is then divided by the number of wireless devices in the cluster to normalize the value to [0, 1].

In some embodiments, a suitability index may comprise a traffic level and load profile (tps) for a wireless device. The tps may be determined based on an amount of throughput delivered to (downlink) and sent from (uplink) the wireless device. In this example, a lower throughput indicates that a wireless device is more suitable to serve as the cluster head, as the wireless device has more bandwidth to communicate with the other wireless devices in the cluster, and to sense objects within the cluster. Lower throughput also indicates that a wireless device has less computational overhead, and that therefore more computational power is available to that wireless device to perform cluster head-related tasks (for example, coordinating the sensing of objects in the cluster environment).

The amount of throughput may be calculated as follows. K throughput values are sampled in T time (where k and T are preset values), and sampled_throughput is the set of all k samples within T. Min-max normalization can be used to determine an average of a sample at time t belonging to T:

$$throughput ( t ) = \frac{sample\_throughput [ t ] - min ( sampled\_throughput )}{max ( sampled\_throughput ) - min ( sampled\_throughput )}$$

This is then repeated for all samples in sampled_throughput, and obtaining an average value will return the normalized bandwidth utilization for that wireless device at time t. Statistics (e.g., average) of this parameter over T can then be determined.

Additionally or alternatively, the traffic level and load profile may be determined based on one or more of metrics that have been provided by the wireless device itself (for example, metrics indicating volatile and non-volatile memory utilization of the wireless device, and/or Central Processing Unit (CPU) utilization of the wireless device). These utilization metrics can also be sampled over a period of time to determine an average value, which can then be used to determine the tps.

In some embodiments, a suitability index may comprise a power profile score (PPS) for a wireless device. In some examples, the PPS may reflect the type of power source (for example, a battery or a mains power supply) for the wireless device, and/or, where the power source is a battery, a depth of discharge of the battery or a state of charge of the battery. Where the PPS reflects the state of charge of the battery, the PPS indicates the normalized level of charge of the battery (normalized to its capacity to give an index in [0,1]). Where the PPS reflects the depth of discharge of the battery, the PPS indicates the normalized level of discharge of the battery. The PPS for a wireless device may be calculated as follows:

$${pps}_{UEx} = \{ \begin{matrix}1 if power\_type = mains \\ {SoC}_{UEx} if power\_type = battery\end{matrix}$$

In some embodiments, the PPS may be based on other factors, such as the capacity of the battery.

In some embodiments, a suitability index may comprise a sensing vision score (svs) for a wireless device. It will be appreciated that, in scenarios in which the head wireless device is expected to transmit sensing beams to assist the other wireless devices in sensing surrounding objects, the head wireless device radio vision to the previously sensed objects should be of high quality. There are several different metrics that can be used to determine the SVS, as discussed at https://www.radartutorial.eu/01.basics/Radars%20Accuracy.en.html. Examples of these metrics include the bearing, range and height accuracy of the wireless device.

In some embodiments, a suitability index may comprise a Channel Quality Indicator (CQI) for a wireless device. The CQI may be in the form of a float in [0,1]. It will be appreciated that it is preferable for a head wireless device to have high radio channel quality, and a low number of communication hops between itself and the other wireless devices in the cluster.

The CQI may be calculated as follows:

$${ces}_{UEx} = \frac{CQI + {avg\_hops}_{UEx}}{2} where …$$

$${CQI}_{UEx} = \frac{{\sum }_{i = 1}^{k} reference\_signal {\_measurement}_{UEx} ( k )}{k}$$

$${avg\_hops}_{UEx} = \{ \begin{matrix}1 if measured\_hops \leq reference\_hops \\ 1 - \frac{measured\_hops}{reference\_hops} if measure\_hops > reference\_hops\end{matrix}$$

where reference_signal_measurement_{UEx}(k) is a 0-1 normalized CQI measurement at time k for UEx. In addition, reference_hops is the number of hops between a UEk and the cluster head that is considered acceptable for a head wireless device. Measured_hops are the measured number of hops, presented as an average for every UEk in the cluster.

In some embodiments, a suitability index may comprise a loss-line of sight score for a wireless device. This may determined as follows:

$${loss}_{UEx} = {w}_{{loss}_{UE}} \cdot \frac{{verified\_loss}_{UE}}{total\_number \_of \_UE - 1} + {w}_{{loss}_{gNB}} + {verified\_loss}_{gNB}$$

The variable verified_lossue is the number out of total_number_of_UE that have line of sight with UEx.

In some embodiments, the first wireless device may be selected according to one or more of these calculated suitability indices. For example, for each wireless device in the cluster, a capability score may be calculated for that wireless device as follows:

$${cap}_{UEx} = \frac{\begin{matrix}{w}_{ces} \cdot {ces}_{UEx} + {w}_{svs} \cdot {svs}_{UEx} + {w}_{pps} \cdot {pps}_{UEx} + \\ {w}_{tps} \cdot {tps}_{UEx} + {w}_{ms} \cdot {ms}_{UEx} + {w}_{loss} \cdot {loss}_{UEx}\end{matrix}}{6}$$

where w_{ces}, wₛᵥₛ, wₚₚₛ, wₜₚₛ, wₗₒₛₛ and wₘₛ are weights for each of the suitability indicators. The weights for calculating the capability score are preset, and may differ depending on specific use cases. One factor weighing into the choice of weights are the relative priorities for sensing accuracy and communication quality. For example, in cases triggered by inaccurate sensing, sensing-quality related indicators, such as sensing vision score svs_UEx and line of sight score loss_UEx, are assigned higher weights, increasing the likelihood that a wireless device capable of performing accurate sensing is selected as the head wireless device. In another example, congestion-triggered cases can have higher weights assigned to communication-quality related indicators, such as the traffic and load profile tps_UEx and Channel Quality Indicator CQI_UEx, increasing the likelihood that a wireless device with high quality communication with the other wireless devices and/or the base station 202 is selected as the head wireless device.

Following the selection of the head wireless devices, the base station 202 transmits, to the head wireless device 204a, a request for objects in the environment of the cluster 208 to be sensed. The base station 202 also transmits, to the head wireless device 204d, a request for objects in the environment of the cluster 210 to be sensed. In other words, the base station 202 initiates a positioning information collection process for the clusters. The aforementioned requests may further comprise information identifying one or more other wireless devices in the clusters and/or information on one or more objects previously sensed by the base station 202.

The head wireless device 204a then coordinates the sensing of objects in the environment of the cluster 208 by one or more other wireless devices in the cluster 208 (that is, the wireless device 204b). The head wireless device 204a transmits to the wireless device 204b, a request for the wireless device 204b to sense objects in its environment (that is, the environment around wireless device 204b). The head wireless device 204a also performs object sensing in its environment, and senses the object 206a and the wireless device 206b.

The wireless device 204b performs object sensing in response to receiving the aforementioned request, and may sense the object 206b. The wireless device 204b then transmits information relating to the object 206b to the head wireless device 204a.

In an alternative embodiment (not illustrated), the head wireless device 204a may instead perform object sensing in the cluster environment, and not request that the other wireless devices in the cluster 208 perform object sensing.

The head wireless device 204a then sends information to the base station 202 comprising information relating to the objects that have been sensed by the wireless devices in the cluster 208. For example, the head wireless device 204a may transmit information relating to the objects 206a and 206b to the base station 202. The head wireless device 204a may also transmit information relating to the wireless device 204b to the base station 202, such as relayed communication data from the wireless device 204b.

The information relating to the objects that have been sensed by the wireless devices in the cluster 208 may indicate any one of the following: locations of the sensed objects (as an absolute location, a location relative to the wireless device that sensed the object, or a location relative the head wireless device 204a), tracking information (i.e. information about the movement) for the sensed objects, the composition of the sensed objects, and dimensions of the sensed objects. In some embodiments, the head wireless device 204a may determine the locations of the sensed objects relative to the base station 202 and transmit this information to the base station 202.

A corresponding process to that described above also occurs for the cluster 210, following receipt of a request for objects in the environment of the cluster 210 to be sensed by the head wireless device 204c.

It will be appreciated that the base station 202 may stop local object sensing (that is, object sensing by the wireless devices in the clusters), and resume global object sensing (that is, object sensing by the base station 202), by sending a stop sensing command to each of the head wireless devices 204a and 204c.

Therefore, the method described with reference to FIGS. 2a and 2b enables the base station 202 to save spectrum and/or resources that previously would have been allocated for object sensing, as the task of object sensing has now been delegated to the clusters of wireless devices 208 and 210. The base station 202 also spends less energy resources, as the base station 202 only has to communicate with the head wireless devices 204a and 204c in order to obtain object-sensing information. In situations in which the object sensing performed by the clusters 208 and 210 is more accurate than that performed by the base station 202 (e.g. such as where the base station 202 does not have line of sight to the objects), the method described with reference to FIGS. 2a and 2b also enables more accurate object sensing.

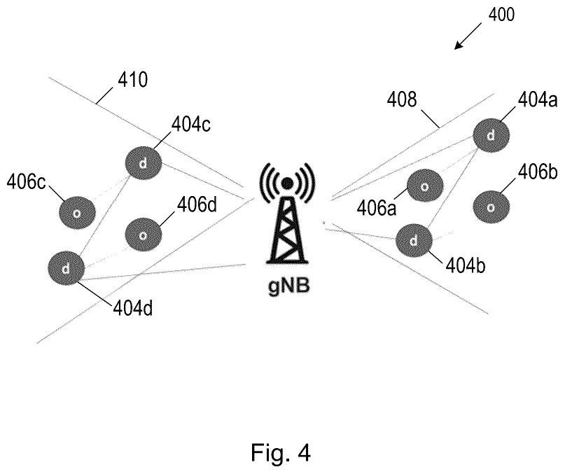

In an alternative embodiment, a base station may defer a sensing process to wireless devices attached to the base station, to autonomously determine what they can sense. In this embodiment, the wireless devices may sense objects not that have not been previously sensed by the base station. An example implementation of such a method is now described with reference to FIG. 4.

FIG. 4 shows a communication network 400. The network 400 comprises a base station (in this case a 5G Node-B, or gNB) 402, wireless devices 404a, 404b, 404c, 404d and objects 406a, 406b, 406c, 406d. Each of the wireless devices 404a, 404b, 404c, 404d are attached to the base station 402, and able to communicate with the base station 402. As noted above, objects 406a, 406b, 406c, 406d may not have been previously sensed by the base station 402.

In a first step of this method, a wireless device in a given cluster of wireless devices is randomly selected. A cluster of wireless devices may comprise a set of wireless devices that share a primary serving cell (P-CELL). A wireless device may be randomly selected from a subset of wireless devices in the given cluster that have not been selected for a particular period of time. In this illustrated embodiment, the base station 402 randomly selects the wireless device 404a in the cluster 408, and the wireless device 404c in the cluster 410. In this embodiment, the cluster 408 comprises the wireless devices 404a and 404b, which share a primary serving cell, and cluster 410 comprises the wireless devices 404c and 404c, which share another primary serving cell.

The base station 402 then transmits a message, in the form of a sensing token, to the wireless devices 404a and 404c respectively. The sensing token comprises a request for objects in the respective cluster environment to be sensed.

The wireless device 404a then determines whether it has the capacity and/or capability to perform object sensing in the cluster environment. For example, the wireless device 404a may determine whether it has a local sensing system, and/or resources available to perform local object sensing. The wireless device 404a also determines whether it has sufficient certainty about its own location. It will be appreciated that, if the wireless device 404a is not certain about its own location, it may not be able to accurately determine the locations of sensed objects, as these locations will be determined with respect to the wireless device's own location. For example, the wireless device 404a may have sufficient certainty about its location if it comprises a landmark node (or anchor node) with a predefined and well-known position.

It will be appreciated that if a wireless device determines that it is not suitable to become head of the cluster, it may pass the sensing token to another wireless device in the cluster, or to the base station 402.

If the wireless device 404a has the capacity and/or capability to perform object sensing in the cluster environment, and has sufficient certainty about its own location, it becomes the head of the cluster 408. The wireless device 404a performs object sensing in the environment in which it is located. In this illustrated embodiment, the wireless device 404a senses the object 406a.

The head wireless device 404a then determines that not all of the wireless devices in the cluster 408 have either: performed object sensing, or declined to perform object sensing. The head wireless device 404a then transmits a sensing token, comprising information relating to the sensed object 406a, to the wireless device 404b (that is, another wireless device in the cluster 408). This transmission may be directly to the wireless device 404b (for example, via a D2D connection), or indirectly via the base station 402. In some examples, if the object 406a has been previously sensed, the head wireless device 404a may only transmit the sensing token to the wireless device 404b. In other words, only information related to newly sensed objects may be transmitted as part of a sensing token.

As noted above, the wireless device 404b shares a P-CELL with the wireless device 404a. By limiting the sensing token (that is, the request for objects to be sensed by the wireless device) to be passed between wireless devices in the same primary cell, this limits the amount of signalling taking place in this opportunistic process, that might otherwise flood the network if it were not limited to wireless devices within the same serving cell.

The wireless device 404b then determines if it has the capacity and/or capability to perform object sensing in the cluster environment and has sufficient certainty about its own location. If so, it becomes the head of the cluster 408. The head wireless device 404b then performs object sensing in the environment in which it is located. In this illustrated embodiment, the wireless device 404b senses the object 406b.

The head wireless device 404b then determines that all the wireless devices in the cluster 408 have performed object sensing, or have declined to do so (for example, if a wireless device has determined it is not suitable to become head of the cluster), and transmits information relating to the sensed objects 406a and 408b to the base station 402.

A corresponding process to that described occurs then for the cluster 410, following receipt of the sensing token by the wireless device 404c.

In an alternative embodiment, the base station 402 may transmit multiple sensing tokens to each of a number of wireless devices in a given cluster.

Therefore, the method described with reference to FIG. 4 enables the base station 402 to save spectrum and/or resources that previously would have been allocated for object sensing, as the task of object sensing has now been delegated to the clusters of wireless devices 408 and 410. The base station 402 also spends less energy resources, as the base station 402 does not have to communicate with each wireless devices in a cluster in order to obtain the object-sensing information for the clusters 408 and 410. In situations in which the object sensing performed by the clusters 408 and 410 is more accurate than that performed by the base station 402, the method described with reference to FIG. 4 also enables more accurate object sensing.

It is noted that the methods described above with reference to FIGS. 2 to 4 comprise actions performed by a base station. However, it will be appreciated that any of the actions described by a base station may, in alternative embodiments, be performed by another suitable network node, such as a wireless access point or an access point.

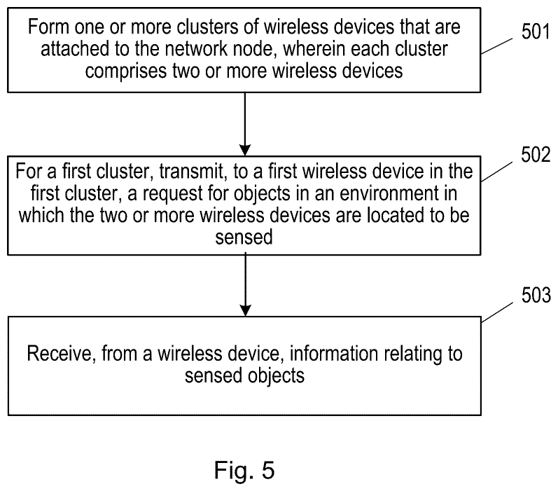

FIG. 5 is a flow chart illustrating a computer-implemented method according to various embodiments performed by a network node in a communication network. In some embodiments, the network node is a base station, an access point or a wireless access point. The network node may perform the method in response to executing suitably formulated computer readable code. The computer readable code may be embodied or stored on a computer readable medium, such as a memory chip, optical disc, or other storage medium. The computer readable medium may be part of a computer program product.

The method may be performed in response to an event at the network node, such as a detection or prediction of congestion at the network node, insufficient resources available at the network node to perform sensing of objects in the environment in which the network node is located, insufficient accuracy in the detection, by the network node, of objects in the environment in which the network node is located or a possibility to save energy at the network node. The event indicates that the network node is to delegate the task of object sensing to a cluster of wireless devices.

In step 501, the network node forms one or more clusters of wireless devices that are attached to the network node, wherein each cluster comprises two or more wireless devices. Step 501 may comprise clustering a plurality of wireless devices in the communication network into the one or more clusters according to one or more of: mobility characteristics of the wireless devices; an ability of wireless devices in a cluster to communicate with each other; and a position of the wireless devices with respect to one or more objects previously sensed by the network node. That is, the one or more clusters may be formed such that they are able to perform object sensing and relay the sensed object information to the network node.

The ability of wireless devices in a cluster to communicate with each other may be determined based on one or more of: one or more direct connections between the wireless devices; one or more indirect connections between the wireless devices; one or more radio connections between the wireless devices and/or the wireless devices and the network node; and a received radio power at one or more wireless devices and/or the network node.

In step 502, for a first cluster, the network node transmits, to a first wireless device in the first cluster, a request for objects in an environment in which the two or more wireless devices are located to be sensed.

The first wireless device may be selected from the two or more wireless devices in the first cluster. For example, the first wireless device may be selected according to one or more of: mobility characteristics; a number of hops between a wireless device in the first cluster and the other wireless devices in the first cluster; traffic level, throughput, and/or load profile of the wireless device; availability of resources in the wireless device; a position of the wireless device in the environment; an indication of a quality of communication between the wireless device and the network node; and whether the wireless device has a line of sight to the network node. In other words, the first wireless device may be selected based on its suitability to act as a “head” or “lead” wireless device, as described with reference to FIGS. 2a and 2b.

The first cluster may further comprise one or more objects previously sensed by the network node. In these embodiments, these one or more objects may impact the formation of the first cluster.

In step 503, the network node receives, from a wireless device, information relating to sensed objects. The information relating to sensed objects may be received from the first wireless device, or from a wireless device in the cluster other than the first wireless device.

Thus, the method enables wireless devices in a network to be clustered for performing object sensing in the cluster environment, and enables the task of object sensing to be delegated from a network node to a cluster of wireless devices. Certain embodiments of this method also enable a head wireless device to be selected for relaying object sensing-related information, and optionally, communication data, to a network node.

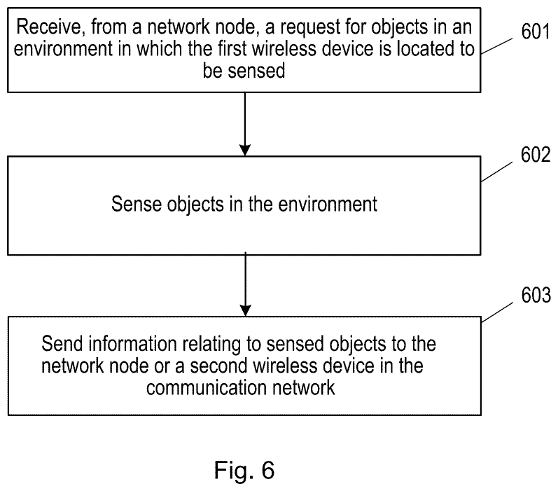

FIG. 6 is a flow chart illustrating a computer-implemented method according to various embodiments performed by a first wireless device in a communication network. The first wireless device may perform the method in response to executing suitably formulated computer readable code. The computer readable code may be embodied or stored on a computer readable medium, such as a memory chip, optical disc, or other storage medium. The computer readable medium may be part of a computer program product.

In step 601, the first wireless device receives, from a network node, a request for objects in an environment in which the first wireless device is located to be sensed. This request indicates to the wireless device that the task of object sensing has been delegated to one or more wireless devices in the communication network, by the network node. In some embodiments, the received request may further comprise information on one or more objects previously sensed by the network node. In some embodiments, the received request may further comprise information identifying one or more other wireless devices. This information may relate to a cluster in which the first wireless device is located. In embodiments in which the first wireless device coordinates the sensing of objects in the environment by one or more other wireless devices, it may use this information to determine this coordination.

In step 602, the first wireless device senses objects in the environment.

In step 603, the first wireless device sends information relating to sensed objects to the network node or a second wireless device in the communication network. When the information is sent to the network node, the network node is able to obtain information relating to sensed objects, without having to perform object sensing itself.

In some embodiments, the first wireless device may coordinate the sensing of objects in the environment by one or more other wireless devices, and the information sent to the network node may comprise information on objects sensed by the one or more other wireless devices. In other words, the information sent to the network node may comprise sensing information for a cluster of one or more wireless devices. In some embodiments, the step of coordinating the sensing of objects may comprise transmitting, to at least one of the other wireless devices, a request for the other wireless device to sense objects, and receiving information relating to objects sensed by at least one of the other wireless devices.

Thus, the method enables the task of object sensing to be delegated from a network node to a wireless device, and, in some embodiments for a first wireless device to obtain object-sensing information that has been performed by a cluster of wireless devices.

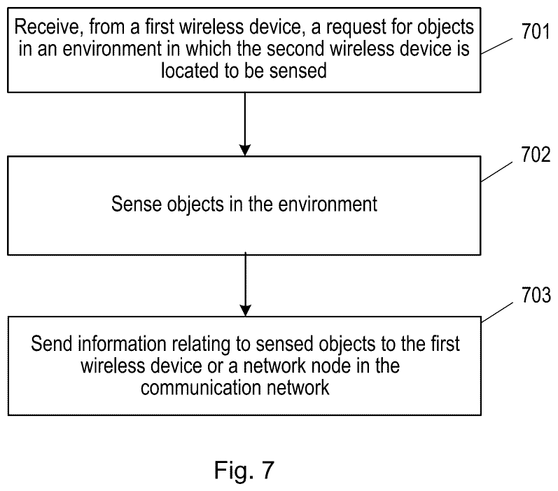

FIG. 7 is a flow chart illustrating a computer-implemented method according to various embodiments performed by a second wireless device in a communication network. The second wireless device may perform the method in response to executing suitably formulated computer readable code. The computer readable code may be embodied or stored on a computer readable medium, such as a memory chip, optical disc, or other storage medium. The computer readable medium may be part of a computer program product.

In step 701, the second wireless device receives, from a first wireless device, a request for objects in an environment in which the second wireless device is located to be sensed. The received request may further comprise information on one or more objects previously sensed by the first wireless device. The received request may further comprise information on one or more objects previously sensed by the first wireless device and one or more other wireless devices.

In step 702, the second wireless device senses objects in the environment.

In step 703, the second wireless device sends information relating to sensed objects to the first wireless device or a network node in the communication network. For example, where the first wireless device is acting as a head wireless device for a cluster, the second wireless device may communicate this information to the first wireless device, such that the first wireless device may communicate this information to the network node.

Thus, the method enables a first wireless device to coordinate object sensing by a second wireless device, and, enables another node in the network (e.g. the first wireless device or a network node) to obtain object-sensing information that has been obtained by the second wireless device.

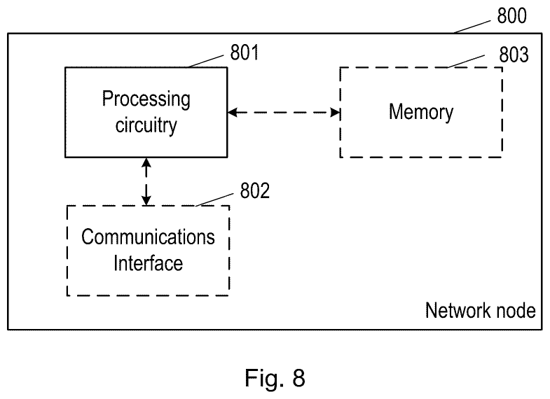

FIG. 8 is a simplified block diagram of a network node 800 according to various embodiments that can be used to implement the techniques described herein. It will be appreciated that the network node 800 may comprise one or more virtual machines running different software and/or processes. The network node 800 may therefore comprise one or more servers, switches and/or storage devices and/or may comprise cloud computing infrastructure that runs the software and/or processes. The network node 800 described herein may be a RAN node, such as a base station, an access point or a wireless access point.

The processing circuitry 801 controls the operation of the network node 800 and can implement the methods described herein in relation to the network node 800. The processing circuitry 801 can comprise one or more processors, processing units, multi-core processors or modules that are configured or programmed to control the network node 800 in the manner described herein. In particular implementations, the processing circuitry 801 can comprise a plurality of software and/or hardware modules that are each configured to perform, or are for performing, individual or multiple steps of the method described herein in relation to the network node 800.

In some embodiments, the network node 800 may optionally comprise a communications interface 802. The communications interface 802 can be for use in communicating with wireless devices. For example, the communications interface 802 can be configured to transmit to and/or receive from wireless devices requests, resources, information, data, signals, or similar. The processing circuitry 801 may be configured to control the communications interface 802 of the network node 800 to transmit to and/or receive from wireless devices requests, resources, information, data, signals, or similar.

Optionally, the network node 800 may comprise a memory 803. In some embodiments, the memory 803 can be configured to store program code that can be executed by the processing circuitry 801 to perform the method described herein in relation to the network node 800. Alternatively or in addition, the memory 803 can be configured to store any requests, resources, information, data, signals, or similar that are described herein. The processing circuitry 801 may be configured to control the memory 803 to store any requests, resources, information, data, signals, or similar that are described herein.

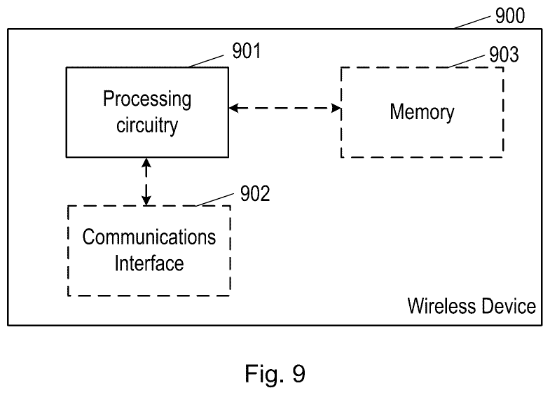

FIG. 9 is a simplified block diagram of a wireless device 900 according to various embodiments that can be used to implement the techniques of operating wireless devices described herein. It will be appreciated that the wireless device 900 may comprise one or more virtual machines running different software and/or processes. The wireless device 900 may therefore comprise one or more servers, switches and/or storage devices and/or may comprise cloud computing infrastructure that runs the software and/or processes.

The processing circuitry 901 controls the operation of the wireless device 900 and can implement any of the methods described herein in relation to a wireless device 900. The processing circuitry 901 can comprise one or more processors, processing units, multi-core processors or modules that are configured or programmed to control the wireless device 900 in the manner described herein. In particular implementations, the processing circuitry 901 can comprise a plurality of software and/or hardware modules that are each configured to perform, or are for performing, individual or multiple steps of the method described herein in relation to the wireless device 900.

In some embodiments, the wireless device 900 may optionally comprise a communications interface 902. The communications interface 902 can be for use in communicating with other wireless devices and/or network nodes, such as a base station. For example, the communications interface 902 can be configured to transmit to and/or receive from other wireless devices or network nodes requests, resources, information, data, signals, or similar. The processing circuitry 901 may be configured to control the communications interface 902 of the wireless device 900 to transmit to and/or receive from other wireless devices and/or network nodes requests, resources, information, data, signals, or similar.

Optionally, the wireless device 900 may comprise a memory 903. In some embodiments, the memory 903 can be configured to store program code that can be executed by the processing circuitry 901 to perform the methods described herein in relation to wireless device 900. Alternatively or in addition, the memory 903 can be configured to store any requests, resources, information, data, signals, or similar that are described herein. The processing circuitry 901 may be configured to control the memory 903 to store any requests, resources, information, data, signals, or similar that are described herein.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the scope of the disclosure. Various exemplary embodiments can be used together with one another, as well as interchangeably therewith, as should be understood by those having ordinary skill in the art.

### REFERENCES

[1] “Establishing a Relative Positioning System to Achieve Mobile Localization”, Brian Copeland, https://dspace.mit.edu/bitstream/handle/1721.1/117300/1046098684-MIT.pdf?sequence=1&isAllowed=y
[2] Pierre Gancarski, Thi-Bich-Hanh Dao, Bruno Crémilleux, Germain Forestier, Thomas Lampert. Constrained Clustering: Current and New Trends. Pierre Marquis, Odile Papini, Henri Prade. A Guided Tour of AI Research, 2, Springer, 2020. Hal-02548212
[3] 3GPP TS 29.168 V17.1.0 (2021-12), 3^{rd} Generation Partnership Project; Technical Specification Group Core Network and Terminals; Cell Broadcast Centre interfaces with the Evolved Packet Core; Stage 3 (Release 17)
[4] 3GPP TS 29.518 V17.7.0 (2022-09), 3^{rd} Generation Partnership Project; Technical Specification Group Core Network and Terminals; 5G System; Access and Mobility Management Services; Stage 3 (Release 17)
[5] X. Duan, Y. Liu and X. Wang, “SDN Enabled 5G-VANET: Adaptive Vehicle Clustering and Beamformed Transmission for Aggregated Traffic,” in IEEE Communications Magazine, vol. 55, no. 7, pp. 120-127, July 2017, doi: 10.1109/MCOM.2017.1601160.
[6] M. Khan, K. Yau, R. Noor, and M. Imran, “Survey and taxonomy of clustering algorithms in 5G,” Journal of Network and Computer Applications, Volume 154, 2020, 102539, doi: https://doi.org/10.1016/j.jnca.2020.102539.

1. A computer-implemented method performed by a network node in a communication network, the method comprising:
forming one or more clusters of wireless devices that are attached to the network node, wherein each cluster comprises two or more wireless devices;
for a first cluster, transmitting, to a first wireless device in the first cluster, a request for objects in an environment in which the two or more wireless devices are located to be sensed; and
receiving, from a wireless device, information relating to sensed objects.

2. A method as claimed in claim 1, wherein the network node comprises a base station, an access point, or a wireless access point.

3. A method as claimed in claim 1, wherein the information relating to sensed objects is received from the first wireless device.

4. A method as claimed in claim 1, wherein the information relating to sensed objects is received from a wireless device in the cluster other than the first wireless device.

5. A method as claimed in claim 1, wherein the method is performed in response to an event at the network node.

6. A method as claimed in claim 5, wherein the event is any of:
a detection or prediction of congestion at the network node;
insufficient resources available at the network node to perform sensing of objects in the environment in which the network node is located;
insufficient accuracy in the detection, by the network node, of objects in the environment in which the network node is located; and
a possibility to save energy at the network node.

7. A method as claimed in claim 1, wherein the first cluster further comprises one or more objects previously sensed by the network node.

8. A method as claimed in claim 1, wherein the step of forming comprises:
clustering a plurality of wireless devices in the communication network into the one or more clusters according to one or more of: mobility characteristics of the wireless devices; an ability of wireless devices in a cluster to communicate with each other; and a position of the wireless devices with respect to one or more objects previously sensed by the network node.

9. A method as claimed in claim 8, wherein the ability of wireless devices in a cluster to communicate with each other is determined based on one or more of: one or more direct connections between the wireless devices; one or more indirect connections between the wireless devices; one or more radio connections between the wireless devices and/or the wireless devices and the network node; and a received radio power at one or more wireless devices and/or the network node.

10. A method as claimed in claim 1, wherein the method further comprises:
selecting the first wireless device from the two or more wireless devices in the first cluster.

11. A method as claimed in claim 10, wherein the first wireless device is selected according to one or more of:
mobility characteristics;
a number of hops between a wireless device in the first cluster and the other wireless devices in the first cluster;
traffic level, throughput, and/or load profile of the wireless device; availability of resources in the wireless device;
a position of the wireless device in the environment;
an indication of a quality of communication between the wireless device and the network node;
whether the wireless device has a line of sight to the network node.

12. A computer-implemented method performed by a first wireless device in a communication network, the method comprising:
receiving, from a network node, a request for objects in an environment in which the first wireless device is located to be sensed;
sensing objects in the environment; and
sending information relating to sensed objects to the network node or a second wireless device in the communication network.

13. A method as claimed in claim 12, wherein the information relating to sensed objects is sent to the network node.

14. A method as claimed in claim 13, wherein the received request further comprises information on one or more objects previously sensed by the network node.

15. A method as claimed in claim 13, wherein the method further comprises:
coordinating the sensing of objects in the environment by one or more other wireless devices; and
wherein the information sent to the network node comprises information on objects sensed by the one or more other wireless devices.

16. A method as claimed in claim 15, wherein the received request further comprises information identifying one or more other wireless devices.

17. A method as claimed in claim 15, wherein the step of coordinating the sensing of objects comprises:
transmitting, to at least one of the other wireless devices, a request for the other wireless device to sense objects; and
receiving information relating to objects sensed by at least one of the other wireless devices.

18. A method as claimed in claim 12, wherein the information relating to sensed objects is sent to a second wireless device in the communication network.

19. A computer-implemented method performed by a second wireless device in a communication network, the method comprising:
receiving, from a first wireless device, a request for objects in an environment in which the second wireless device is located to be sensed;
sensing objects in the environment; and
sending information relating to sensed objects to the first wireless device or a network node in the communication network.

20. A method as claimed in claim 19, wherein the information relating to sensed objects is sent to the first wireless device.

21.-36. (canceled)
